(19) United States
(12) Patent Application Publication
(10) Pub. No.: US 2011/0018353 A1
(43) Pub. Date: Jan. 27, 2011

(54) Method and apparatus for multi-source electrical energy grid-tied transformation

(76) Inventor: Wenjiang Yu, Mississauga (CA)

Correspondence Address: Wenjiang Yu, 1837 Truscott Dr., Mississauga, ON, L5J 2A1, CA

(21) Appl. No.: 12/508,546

(22) Filed: Jul. 23, 2009

(51) Int. Cl. H02J 5/00

(52) U.S. Cl. 307/82; 307/43

(57) ABSTRACT

A method and apparatuses transform the electrical energy from multiple sources to grid compliant AC voltage. The apparatus according to one embodiment comprises: multiple energy sources (GES 1 to m in FIG. 1) from various power conversion devices; controllers (GER 1 to m in FIG. 1) pumping the maximum available electrical power to the DC inter-source bus; a hybrid inter-source DC bus carrying the electrical power from controllers to inverters and load level information among inverters; and inverters (CNT 1 to k) converting the DC power from the inter-source DC bus to grid compliant AC power.

### BACKGROUND OF THE INVENTION

1. Field of Invention

The present invention relates to electric power transformation systems, and more particularly to a method and apparatus for converting the electrical energy from multiple sources to grid compliant AC voltage.

2. Description of Related Arts

Growing green energy harvesting methods, such as small wind and solar electric power generation, create unique opportunities contributing to the long term global energy solution without jeopardizing environmental sustainability. Viable application methods of these green energy sources are based on distributed electric power generation.

Distributed generation has many traits including power security and improved distribution efficiency, meanwhile there arise new problems when they are tied to the existing electric power generation and application configuration that has been designed and operated with the implication that electric power are intensively generated in various locations.

To utilize the electric power with distributed generation sources, a means must be provided to align the power generation with the power application at same or nearby site, this is important because the time when the power is generated at one location may not be the time when the power is used, at same location. Power storage is one method to solve the problem, tying the distributed sources to the power grid, where it is available, is another method that is economically viable. This patent is associated with the second method.

Tying the distributed power generation sources to electric grid helps solve the green power generation and application problem mentioned above in two aspects, one is that the power grid system has the adaptive capability provided by the power plants on the same grid, the other is that power grid works as an pool to smooth out the peak and sag due to spontaneous generation and application occurrences. To elaborate this with an exemplary scenario, at one location when the power is generated but not used at the same time, somewhere nearby is using power but not generating power. By tying both sites to the grid, the site using power will consume the power generated at the other site where the power is not used at the moment. At another time or combination this scenario may be reversed. Statistically, with sufficient amount of the sites tied to the grid, the generation and application will even out at any given time assuming the installation capacity is equal to the consumption demand.

To make the above scheme work, every one of the generation sources must be able to tie to grid. System level constrains for each source to tie to grid include that the grid capacity must be large enough to accommodate the fluctuation caused by distributed generation sources, which is generally true considering the statistic even out effect mentioned above. The challenges reside with the distributed generation sources to be viable energy alternatives economically and reliably when tied to grid individually. This intention has to do with these challenges.

Prior arts include transforming electric power from multiple connected solar panels to the form to be able to tie to grid. The capacity of each panel is limited to a few hundreds of watts. To make the transformation economically viable given the reliability demand in the utility industry, many panels are connected together before transformation. Efficiency problem arises in this type of setup when panels output unequally. Similar problems exist when small wind tie together before a transformation stage converts their power output into power grid format; Prior arts also include small electric power inverters that transform the electric output from one solar panel or one small wind turbine into the grid format power and tie to grid. To make this configuration economically viable, the inverter has to be down graded in design complexity and therefore reliability and quality suffer.

### SUMMARY OF THE INVENTION

The hereafter concerned invention aims to use two stage transformation, redundant techniques and inter-source collaboration to address the efficiency, reliability and cost issues in a single configuration.

Electrical energy sources can be solar panel, wind turbine or any other types of small scale (a few watts to a few thousands of watts in general) alternative electric power sources. The controllers in this configuration refer to the devices that collaborate with other similar ones connected to the same inter-source power and intelligence bus to extract maximum available power from the corresponding green power source at any given time.

The controller is designed with simplicity and robustness to minimize the cost and eliminate negative impact on the bus due to failure, other than the loss of the affected source/sources.

The inverters are devices responsible for maintaining the optimal status of the inter-source power bus, which is required for each controller to work to output maximum power from its connected source by coordinating with other similar ones on the bus, transforming the electric power from the inter-source bus to the grid bus, and playing redundant roles when any one of the inverters in parallel fails.

The inverters communicate to each other about their own output level relative to individual capacities through the inter-source DC bus and coordinate the output level of each inverter to maintain maximum output efficiency based on a pre-set profile.

### BRIEF DESCRIPTION OF THE DRAWINGS

Further aspects and advantages of the present invention will become apparent upon reading the following detailed description in conjunction with the accompanying drawings, in which:

FIG. 1 is a block diagram of an electrical system containing a multiple electrical power sources, controllers, hybrid DC bus and converters according to an embodiment of the present invention;

FIG. 2 is an exemplary block diagram of principle and function of the wind turbine controller according to an embodiment of the present invention;

FIG. 3 is an exemplary block diagram of principle and function of the solar panel controller according to an embodiment of the present invention;

FIG. 4 is an exemplary block diagram of principle and function of the inverter according to an embodiment of the present invention;

FIG. 5 is an exemplary block diagram to achieve the DSP control functions in FIG. 4 according to an embodiment of the present invention;

### DETAILED DESCRIPTION

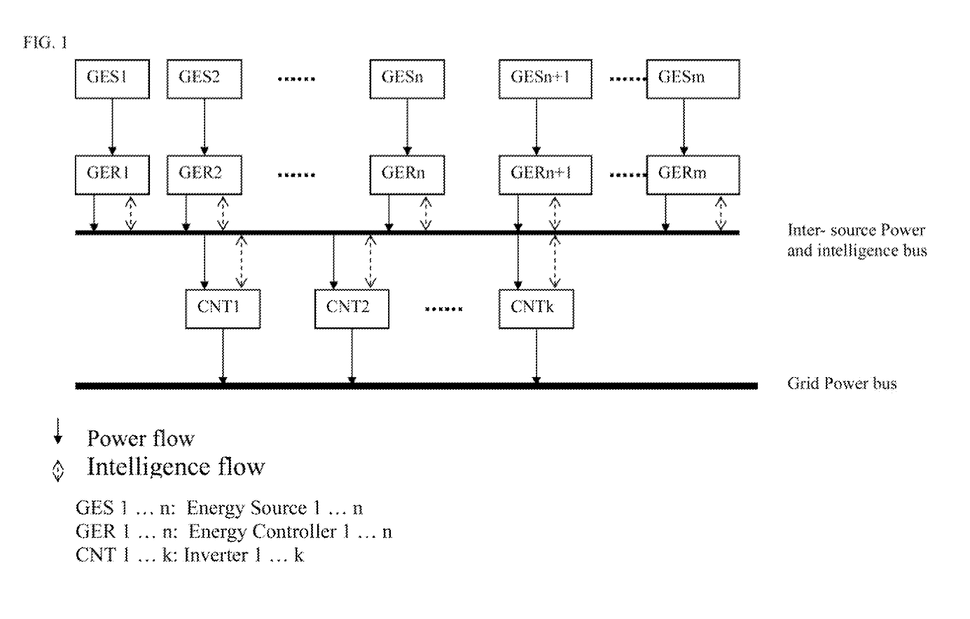

Top level configuration in this invention is illustrated in FIG. 1.

In this configuration, green energy sources can be solar panel, wind turbine or any other types of small scale (a few watts to a few thousands of watts in general) alternative electric power sources. The green energy controllers in this configuration refer to the devices that collaborate with other similar ones connected to the same inter-source power and intelligence bus to extract maximum available power from the corresponding power source at any given time, based on the intelligence flown on the bus. The controller is designed with simplicity and robustness to minimize the cost and eliminate negative impact on the bus due to failure, other than the loss of the affected source/sources. The inverters are devices responsible for maintaining the optimal status of the inter-source power bus, which is required for each controller to work to output maximum power from its connected source, by coordinating with other similar ones on the bus and sending power status intelligence to the controllers, transform the electric power from the inter-source bus to the grid bus, and play redundant roles when any one of the inverters in parallel fails. The number of the inverters is determined by the formula below,

C_{CNT}×(k−1)>C_{GES 1 . . . n}×n+C_{GESn+1 . . . m}×(m−n)

Assuming,
(1) All inverters have same capacity of C_{CNT}
(2) All energy sources from l to n have same capacity of C_{GES1 . . . n}
(2) All energy sources from n+1 to m have same capacity of C_{GESn+1 . . . m}

This configuration has a few features making it reliable and cost effective,
(1) Each inverter is backed up by all other ones on the bus. A failed inverter will be detected and reported by others.
(2) Each inverter can be withdrawn from or added to the configuration without interrupting the system operation.
(3) All controllers detect the status of the inter-source bus and maintain maximum output from its corresponding source, based on the detection of the intelligence on the inter-source bus.
(4) Inter-source bus status is monitored and maintained by the self-coordinated inverters.
(5) Controllers are simplified for cost and reliability advantages.
(6) Controllers are designed so that the failed controller will not have negative impact other than the lost power output from itself.
(7) Intelligences, such as power bus status, status of other controllers and inverters, grid bus status and system operating conditions are communicated through the inter-source power and intelligence bus

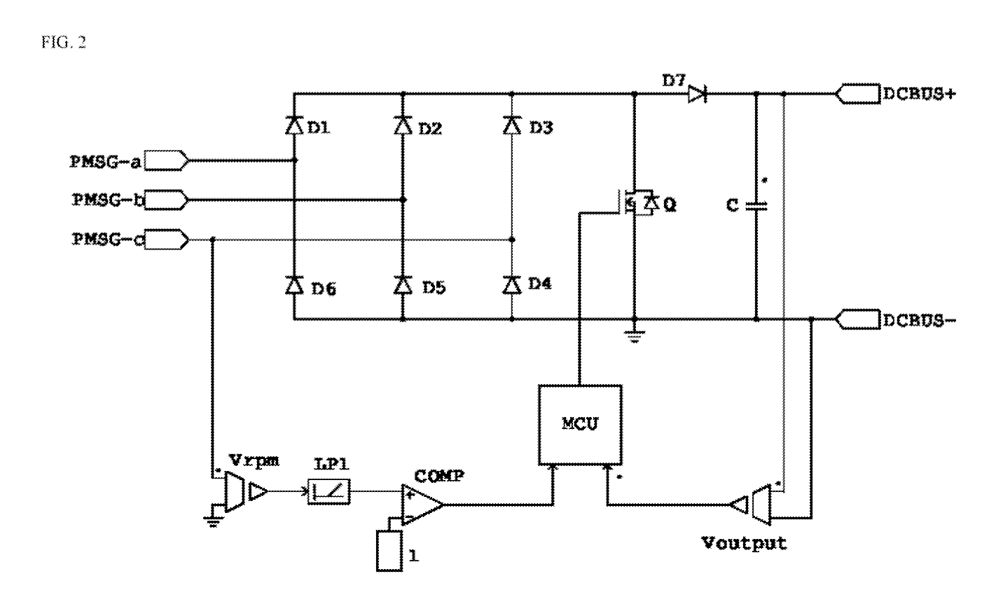

The principle of the controller can be referred to FIG. 2. The controller monitor the inter-source bus voltage, DCBUS+ to DCBUS−, and control the boost switch, Q in FIG. 2, turns on and off at certain time and frequency, so the output potential of controller would always exceed the inter-source bus voltage, DCBUS+ to DCBUS−, until the power from the source are exhausted. The operation described above would maintain the amount of power pumped to inter-source bus at optimum level.

Depends on the type of power sources, the control circuit could use different algorithm to control boost switch operates at maximum power output point. For example, for wind turbine controller; the boost switch duty cycle could be programmed based on the wind turbine RPM to power curve. For photovoltaic panel, the boost switch duty cycle could be programmed based PV MPPT power curve.

The controller control circuit protects the system from over voltage. It senses the output voltage, once its output voltage goes over certain value, the boost switch, Q in FIG. 2, would be controlled so that the output would be held lower than the protection value. This over voltage situation would happen if lack of protection in the cases of controller open circuit or inverters faulty condition.

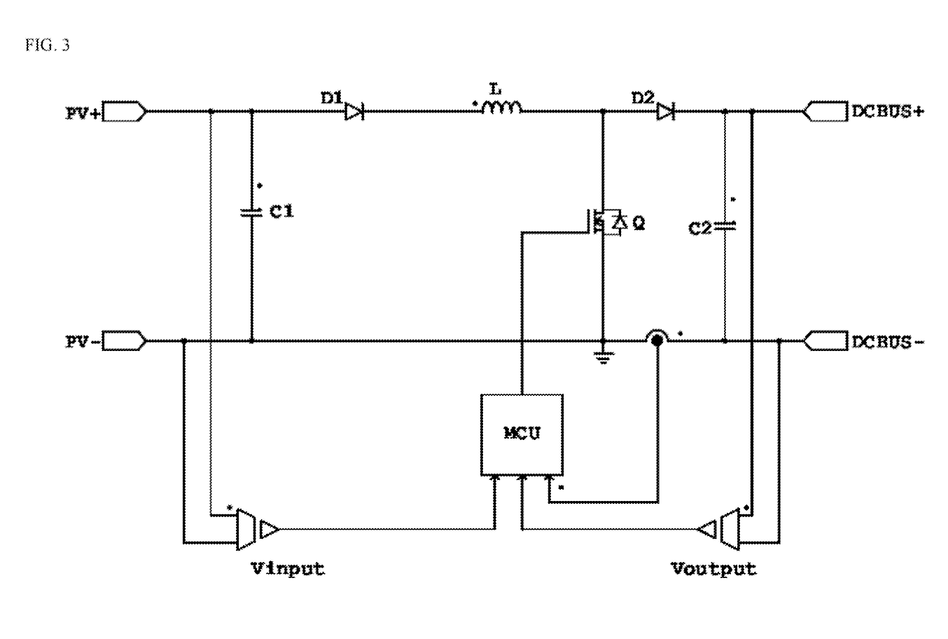

FIGS. 2 and 3 illustrate the principle and function of the wind and solar controller respectively.

To further illustrate how the concerned controller works, FIG. 2 shows the internal diagram of a wind turbine controller, it takes input electric power from wind turbine alternator and boosts it to the inter-source bus, DCBUS+ to DCBUS−. Wind turbine generator has three phase output connected to the controller input PMSG-a, PMSG-b and PMSG-c. These three phase output are variable voltage and frequency electric power source, their value changes related to blade rotation speed driven by wind speed. Higher wind speed will result higher voltage and frequency.

The concerned wind turbine controller, as illustrated in FIG. 2, consists of 3 phase rectifier block, boost switch device, signal sensing device and maximum power tracking control circuit. Below is an explanation how each of the parts works.

In FIG. 2, D1 to D6 are 3 phase rectifier block. No explanation is necessary for this part.

In FIG. 2, Q, D7, turbine generator internal equivalent inductance (not shown here) and C form the boost stage. There is no filtering capacitor after rectifier output so the turbine generator internal equivalent inductance can be used for boosting inductance purpose. The boosting duty cycle is determined by MCU based on RPM signal.

One phase of the turbine generator output is sampled and filtered to generate the RPM signal, which is proportional to wind turbine rotor speed. MCU takes the RPM signal into the lookup table, finds the corresponding duty cycle then drives Q in the boost circuit, consequently bump the corresponding maximum power to the inter-source bus.

To provide the protection function mentioned above, the MCU senses the output voltage, thus the inter-source bus voltage, and disable the boost circuit in the case that output voltage goes over certain value, for example 190V+10V in a typical design.

FIG. 3 shows how the solar power controller works. The output electric power of PV cell fluctuates accordingly to environmental factors, such as illumination and temperature. Since the characteristic curve of a solar cell exhibits a nonlinear voltage-current characteristic, a Maximum Power Point Tracking (MPPT) algorism is required to extract maximum electric power generated with the solar cell. Many algorithms have been developed for tracking maximum power point of a solar cell. Because the output energy of the PV arrays changes frequently by the surroundings, improving the response speed of tracking control system may improve the power harvesting performance of the system. The publicly known tracking control methods for the MPPT can be classified into five categories:
(i) Hill-climbing
(ii) Incremental conductance
(iii) Open-circuit voltage and short-circuit current
(iv) Fuzzy logic control
(v) Neural network control

All above algorithms can be achieved with the hardware circuit illustrated in FIG. 3, the concerned solar panel controller consists with C1, C2, L, Q, D1 and D2. The MCU can use any of above five MPPT control algorithms to control the boost switch Q, so the available maximum power would be pumped into inter-source bus.

Same as wind turbine controller, the output voltage on inter-source bus is not regulated, and the potential always exceeds the inter-source bus voltage, up to a limit (190V in a typical design) if the controller is open circuit.

To provide the protection function mentioned above, the MCU senses the output voltage, the inter-source bus voltage, and disable the boost circuit in the case that output voltage goes over certain value, for example 190V+10V in a typical design.

The inverters in this configuration have two functions, one is to convert the power from the inter-source DC bus to the grid standard, the other is maintaining the inter-source bus at desired voltage value by adjusting its output capacity.

The inter-source bus is set to certain voltage (190V in a typical implementation). All controllers would boost their output voltage to exceed this value until the available electrical power from their corresponding sources are exhausted. The non-active controller like non-spin wind turbine would not output more than this voltage at this time, thus no power output to the inter-source bus.

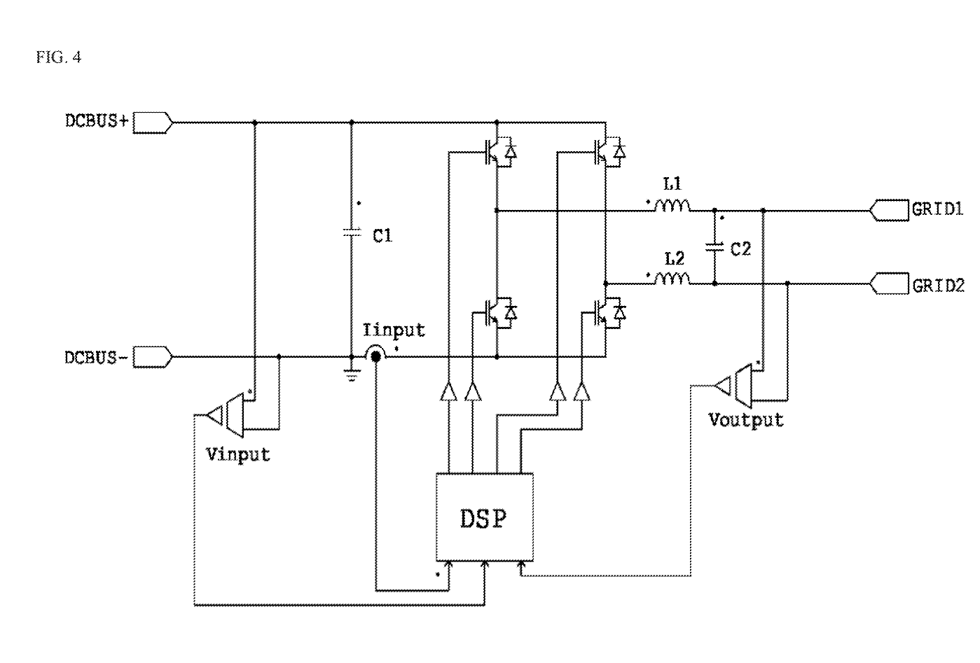

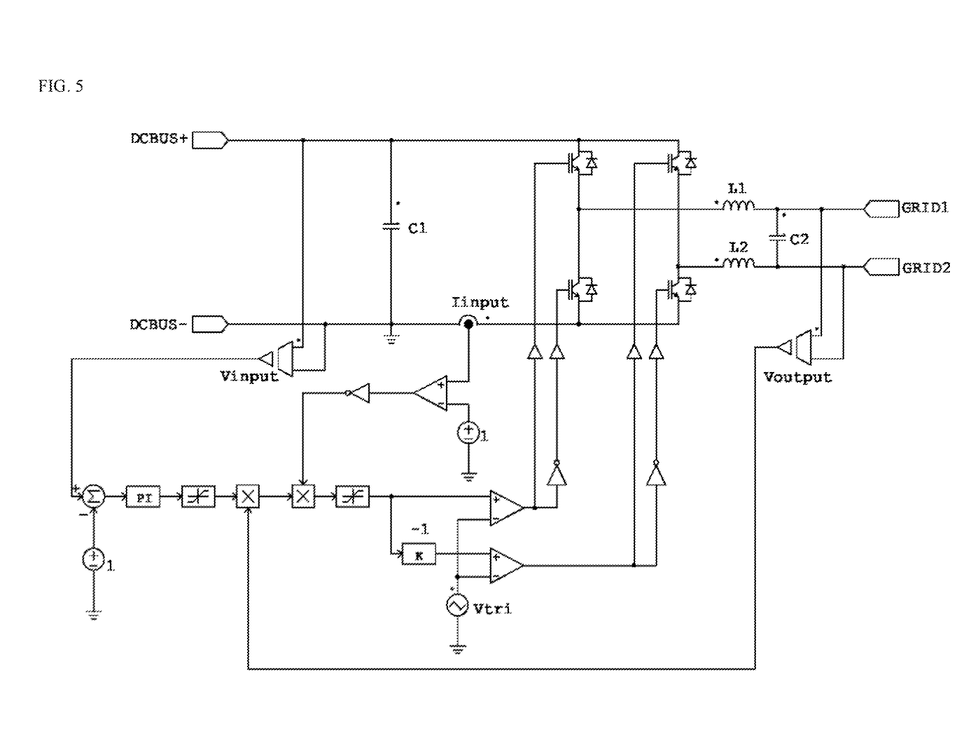

FIGS. 4 and 5 show two inverter examples with function described above.

The inverter is connected between inter-source bus and power grid, its main function is to convert inter-source bus DC voltage to grid standard AC power and to pump maximum power available from the inter-source bus to the grid while maintaining inter-source bus voltage at desired level, for example 190V in a typical implementation.

FIG. 4 is a digital circuit solution to achieve the inverter function described above. Inter-source bus voltage, grid voltage and DCBUS current signals are sampled into DSP controller, the DSP controller then output four PWM signals to drive the H bridge MOSFETs to convert the DC to AC thus output power to grid. The DSP will drive the H bridge to output such amount of power to just enough to bring the inter-source bus to desired voltage level, such as 190V in a typical implementation.

The scenario below is to explain how the converter pumps maximum power available from the inter-source bus to the grid by maintaining inter-source bus voltage at desired level, for example 190V in a typical implementation. If the energy source of inter-source bus reduced, for example a wind turbine output declines because the wind slows down, the DSP will reduce inverter output power to bring the inter-source bus voltage up to desired voltage, such as 190V in a typical implementation. If the source of inter-source bus increased, for example a wind turbine output increases because the wind speeds up, the control circuit, the DSP in this case, will increase the inverter output power to lower the DC BUS voltage down to desired voltage.

The control circuit, the DSP controller in this case, protects the converter by constantly monitoring the output current and limit output current if determined to be necessary. For instance, if the current reach the pre-set value, i.e. the maximum current allowed, the DSP will maintain the amount of power output to grid at the limit level, regardless the inter-source bus voltage would higher than desired value. This will in turn cause the controllers described above to limit their outputs by braking the turbine, stop PV boosting or bypassing the source to a dummy load.

FIG. 5 is an example to achieve the inverter control function illustrated in FIG. 4, with all basic digital functions detailed.

As the way the inverters defined to work, they could be simply paralleled on single inter-source bus and will be work well. No master/slave inverter topology needed to define.

We claim:

1) Inter-source hybrid bus structure system to convert the electrical energy from multiple sources to grid compliant AC voltage.

2) The system in claim 1 further includes multiple controllers that pump their own sources energy to inter-source bus.

3) The controllers of claim 2 have no voltage output regulation function.

4) The controllers of claim 3 pump the maximum available power from its source to the DC bus.

5) The controllers of claim 4 can disable its own boosting circuit in the case of inter-source voltage higher than desired level.

6) The system in claim 1 further includes inverters that convert inter-source bus DC voltage to grid compliant AC voltage.

7) The inverters in claim 6 output available power based on maintaining inter-source bus voltage at a desired level.

8) The inverters in claim 7 will limit their output power level to a pre-set maximum level in the case of combined inter-source capacity higher than desired level.

9) The inverters in claim 7 will communicate to each other about their own output level relative to individual capacities through the inter-source bus DC with a heart beat signal.

10) The inverters in claim 9 will coordinate the output level of each inverter to maintain maximum output efficiency based on a pre-set profile.
